(19) United States
(12) Patent Application Publication
(10) Pub. No.: US 2007/0212035 A1
(43) Pub. Date: Sep. 13, 2007

(54) Steam generating apparatus

(75) Inventor: Jang-keun Oh, Gwangju-city (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/595,277

(22) Filed: Nov. 9, 2006

(30) Foreign Application Priority Data
Mar. 6, 2006 (KR) 10-2006-0020777

(51) Int. Cl. H05B 3/78

(52) U.S. Cl. 392/447

(57) ABSTRACT

A steam generating apparatus is provided that includes a first water tank; a second water tank in fluid communication with the first water tank so that the water flows into the second water tank from the first water tank; and a heater heating the water inside the second water tank; wherein the first and second water tanks store water, wherein the heater heats only the water inside the second water tank so as to quickly generate steam.

### CROSS-REFERENCE TO RELATED APPLICATIONS

This application claims benefit under 35 U.S.C. § 119(a) of Korean Patent Application No. 2006-20777, filed Mar. 6, 2006 in the Korean Intellectual Property Office, the entire contents of which are incorporated herein by reference.

### BACKGROUND OF THE INVENTION

1. Field of the Invention

The present disclosure relates to a steam generating apparatus. More particularly, the present disclosure relates to a steam generating apparatus configured to store water and to heat the stored water to steam.

2. Description of the Related Art

A steam generating apparatus is used in various apparatuses such as steam cleaners, humidifiers, skin moisture suppliers, and so on. The steam generating apparatus includes a water-storing tank, a heater, a water inlet, and a steam discharging port. The water-storing tank preferably has a large size for storing water as much as possible so that the cycle of supplying water to the water-storing tank is increased. However, it takes much time for the steam generating apparatus with a large capacity water-storing tank to generate steam because the whole stored water is required to be heated. Especially, even when a small quantity of steam is required, the whole stored water should be heated so that a steam generating efficiency is decreased.

For an example, a Korean Patent Publication No. 10-1995-0000110 discloses a steam injection control apparatus that has a water tank formed by a top tank and a bottom tank coupled using several bolts and nuts, and a heater disposed under the water tank and heating the whole water stored in the water tank in order to generate steam. Also, a Korean Utility Patent No. 20-0404941 discloses a heating apparatus for a steam cleaner that includes a heater disposed at a water tank having a water inlet and a steam discharging port at both sides thereof, and heats the whole water stored in the water tank in order to generate the steam.

As described above, in the conventional steam generator, a large water tank can increase the cycle of supplying water. However, because the whole water stored in the water tank needs to be heated, it has drawbacks that a heat loss is great, and it takes much time to generate the steam.

### SUMMARY OF THE INVENTION

The present disclosure has been developed in order to overcome the above drawbacks and other problems associated with the conventional arrangement. An aspect of the present disclosure is to provide a steam generating apparatus having a convenient large water tank and capable of decreasing the time that to generate steam takes.

Another aspect of the present disclosure is to provide a steam generating apparatus capable of decreasing a heat loss when it generates a small amount of steam. The above aspect and/or other feature of the present disclosure can substantially be achieved by providing a steam generating apparatus, which includes a first water tank; a second water tank in fluid communication with the first water tank so that the water flows into the second water tank from the first water tank; and a heater heating the water inside the second water tank; wherein the first and second water tanks store water, wherein the heater heats only the water inside the second water tank so as to quickly generate steam. As a result, the amount of water capable of storing is large and a steam generating waiting time can be shortened.

Also, the steam generating apparatus according to the present disclosure further comprises a nozzle unit disposed at the second water tank; wherein when to discharge steam from the second water tank through the nozzle unit causes a pressure difference between the first water tank and the second water tank, the water stored in the first water tank flows into the second water tank until the second water tank is equal to the first water tank in the pressure.

According to an embodiment of the present disclosure, the second water tank may be disposed inside the first water tank. Also, the first water tank comprises a water inlet through which the water is poured; and a cap opening or closing the water inlet. The second water tank comprises an opening formed at a sidewall of the second water tank, and the water stored in the first water tank flows into the second water tank through the opening. The first water tank is under the atmosphere pressure because the first water tank is in fluid communication with outside, and the second water tank is under a pressure higher than the atmosphere pressure so that a water level of the first water tank is always higher than that of the second water tank.

Here, the first water tank comprises a water inlet for pouring water and a cap opening or closing the water inlet, and the second water tank comprises a nozzle unit for discharging steam.

It is preferable that a hole is formed at the cap so that a first inner space of the first water tank is in fluid communication with outside.

Also, the nozzle unit is closed at normal times. When the pressure of steam of the second water tank is increased, the nozzle unit is opened the steam discharged to outside. When the pressure of the steam of the second water tank is decreased, the nozzle unit is closed again.

Also, the nozzle unit comprises: a steam pipe disposed through a bottom surface of the second water tank; a case wrapping around at least some part of the steam pipe and having a discharging port; a piston member disposed inside the case so as to open or close the discharging port; and an elastic member disposed between the piston member and the steam pipe.

Also, it is preferable that at least part touching the discharging port of the piston member is made of a soft material.

Other objects, advantages and salient features of the disclosure will become apparent from the following detailed description, which, taken in conjunction with the annexed drawings, discloses preferred embodiments of the disclosure.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a top perspective view illustrating a steam generating apparatus according to an embodiment of the present disclosure;

FIG. 2 is an exploded side perspective view illustrating the steam generating apparatus of FIG. 1;

FIG. 3 is a partial cutaway perspective view illustrating the steam generating apparatus of FIG. 1 for showing the inside thereof;

FIG. 4 is a sectional view illustrating the steam generating apparatus of FIG. 1;

FIG. 5 is an exploded perspective view illustrating a nozzle unit of the steam generating apparatus of FIG. 1;

FIG. 6 is a perspective view illustrating a piston member of the nozzle unit of FIG. 5;

FIG. 7 is a sectional view illustrating the steam generating apparatus of FIG. 1 when water is stored;

FIG. 8 is an enlarged sectional view illustrating a nozzle unit of the steam generating apparatus of the FIG. 7;

FIG. 9 is a sectional view illustrating the steam generating apparatus of FIG. 1 when the nozzle unit is opened to inject the steam;

FIG. 10 is an enlarged sectional view illustrating the nozzle unit of the steam generating apparatus of the FIG. 9; and

FIG. 11 is a perspective view illustrating an example of a steam cleaner having the steam generating apparatus of FIG. 1.

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present disclosure will be described in detail with reference to the accompanying drawings.

The matters defined in the description, such as a detailed construction and elements thereof, are provided to assist in a comprehensive understanding of the disclosure. Thus, it is apparent that the present disclosure may be carried out without those defined matters. Also, well-known functions or constructions are omitted to provide a clear and concise description of exemplary embodiments of the present disclosure.

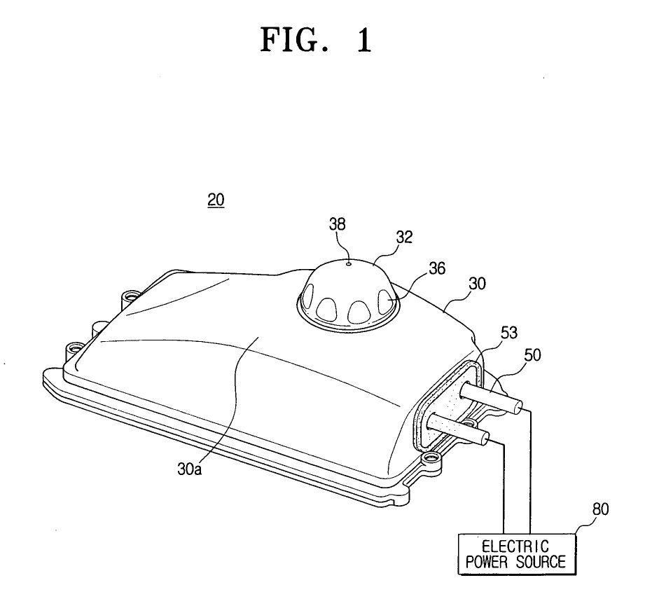

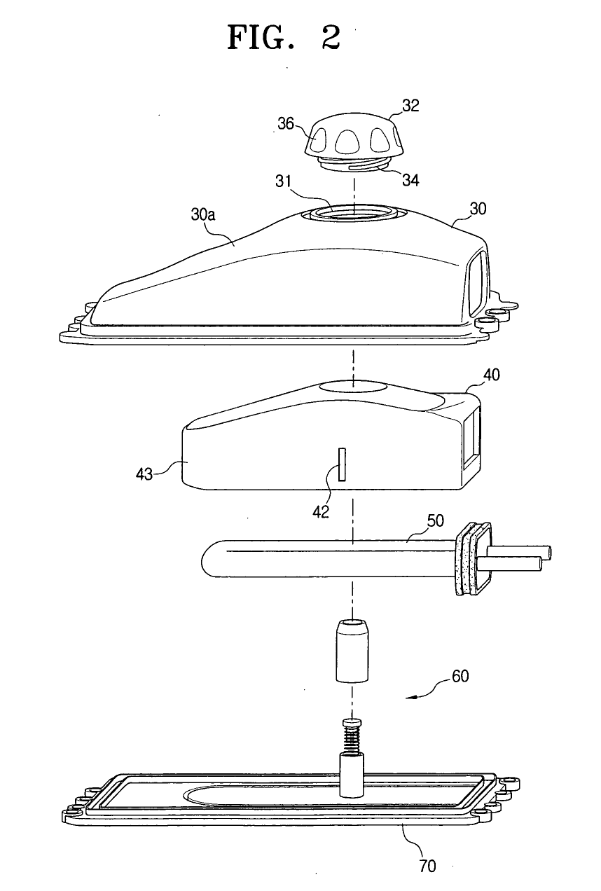

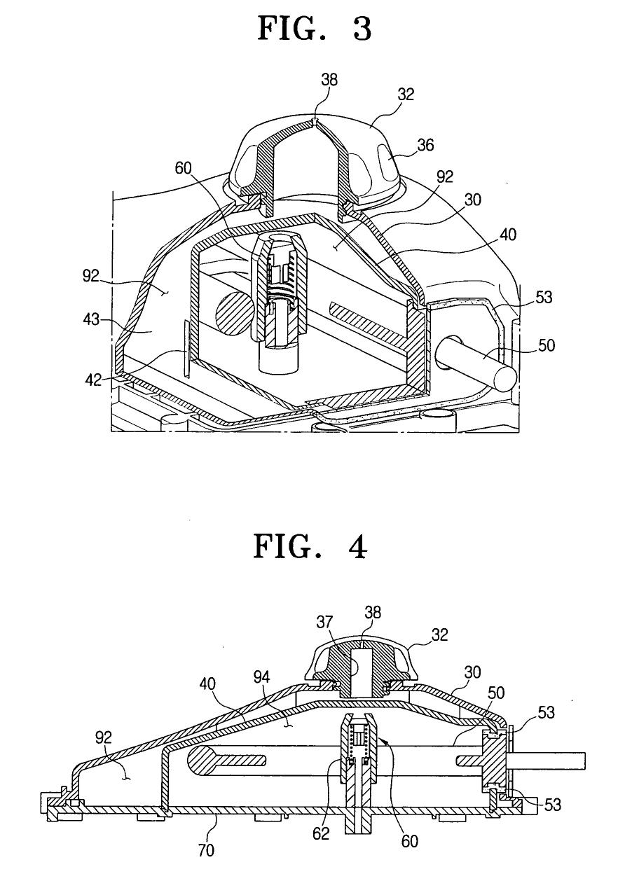

FIG. 1 is a perspective view illustrating a steam generating apparatus according to an embodiment of the present disclosure, FIG. 2 is an exploded perspective view illustrating the steam generating apparatus of FIG. 1, FIG. 3 is a partial cutaway perspective view illustrating the steam generating apparatus of FIG. 1 for showing the inside thereof, and FIG. 4 is a sectional view of the steam generating apparatus of FIG. 1.

Referring to FIGS. 1 to 4, the steam generating apparatus 20 according to an embodiment of the present disclosure includes a first water tank 30, a second water tank 40, a heater 50, a nozzle unit 60, and an electric power source 80.

The first water tank 30 wraps around the second water tank 40, and is connected to a bottom plate 70 so as to form a closed space for storing water. A bottom surface of the first water tank 30 is the bottom plate 70 so as to be flat, but a top surface 30a of the first water tank is a curved surface. A water inlet 31 for pouring water is formed at a top end of the curved top surface 30a, and is opened or closed by a cap 32. The cap 32 has a hole 38 as showed in FIGS. 3 and 4. The hole 38 is connected to a long hollow 37 formed in the cap 32 so that it enables a first inner space 92 of the first water tank 30 to be in fluid communication with the atmosphere outside of the apparatus 20. The cap 32 has a plurality of grooves 36 at a circumferential surface thereof so as to prevent a user's hand from slipping when the user grips the cap 32. The cap 32 has a screw thread 34 (see FIG. 2) at a bottom part thereof to be engaged with a nut thread (not shown) of the water inlet 31.

The second water tank 40, referring to FIGS. 2 to 4, is disposed inside the first water tank 30, and is connected to the bottom plate 70 so as to form a second inner space 94. The second water tank 40 is spaced apart from the first water tank 30 so that the first inner space 92 capable of storing water is formed between the first water tank 30 and the second water tank 40. An opening 42 is formed at a sidewall 43 of the second water tank 40 so as to enable the second inner space 94 of the second water tank 40 to be in fluid communication with the first inner space 92 of the first water tank 30. As a result, the water stored in the first inner space 92 of the first water tank 30 can flow into the second inner space 94 of the second water tank 40.

The heater 50, referring to FIGS. 2 to 4, is disposed inside the second water tank 40 in the lengthwise direction of the second water tank 40. In this embodiment, the heater 50 is formed in the shape of a letter ‘U’, and is connected to the outside electric power source 80 through a sidewall common to the first water tank 30 and the second water tank 40. A packing member 53 seals a side opening of the sidewall through which the heater 50 passes so as to prevent water or steam from leaking from the side opening.

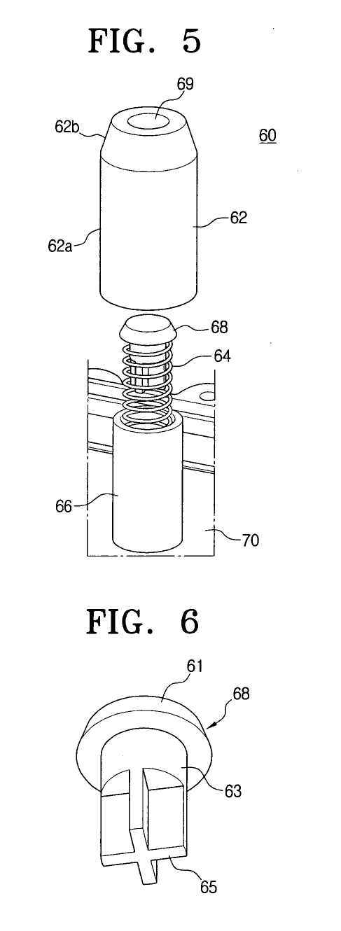

The nozzle unit 60 is disposed inside the second water tank 40, and especially, is disposed vertical to the bottom surface of the second water tank 40, that is, the bottom plate 70, as shown in FIGS. 2 and 4. Referring to FIGS. 4 to 6, the nozzle unit 60 includes a case 62, a piston member 68, an elastic member 64, and a steam pipe 66. The steam pipe 66 is formed integrally with the bottom plate 70 of the second water tank 40, and enables the second inner space 94 of the second water tank 40 to be in fluid communication with outside through the bottom plate 70 so as to serve as a passage through which steam is discharged to the atmosphere. The case 62 has a discharging port 69 at a top end thereof, and an inside of the case 62 connected to the discharging port 69 is penetrated in a lengthwise direction so that the case 62 has a substantially tube shape. The case 62 comprises a curved part 62b and a linear part 62a. The curved part 62b has outer and inner diameters decreasing from a bottom end to a top end so that the top end of the curved part 62b has the smallest outer and inner diameters. Referring to FIG. 4, the case 62 is disposed to wrap around some part of the steam pipe 66. The piston member 68 and the elastic member 64 are disposed inside the case 62. Referring to FIG. 6, the piston member 68 has a touching part 61 and a supporting projection 63. The touching part 61 has a diameter larger than those of the supporting projection 63 and the discharging port 69 of the case 62 so as to close the discharging port 69 when the elastic member 64 pushes the touching part 61 upward. Therefore, the touching part 61 is preferably made of a soft material. In this embodiment, both of the touching part 61 and the supporting projection 63 are made of rubber. However, the supporting projection 63 can be made of other materials such as a plastic. As shown in FIG. 6, the touching part 61 has a diameter decreasing from the bottom end to the top end for the airtightness, and an under part of the supporting projection 63 comprises a cross part 65 to support elastic member 64. The nozzle unit 60 according to this embodiment uses a spring as the elastic member 64. The spring 64 has a diameter that is smaller than that of the touching part 61 of the piston member 68, is larger than that of the supporting projection 63, and is larger than an inner diameter of the steam pipe 66. Therefore, as shown in FIG. 5, the spring 64 is disposed between the piston member 68 and the steam pipe 66 so as to press the piston member 68 in an upward direction.

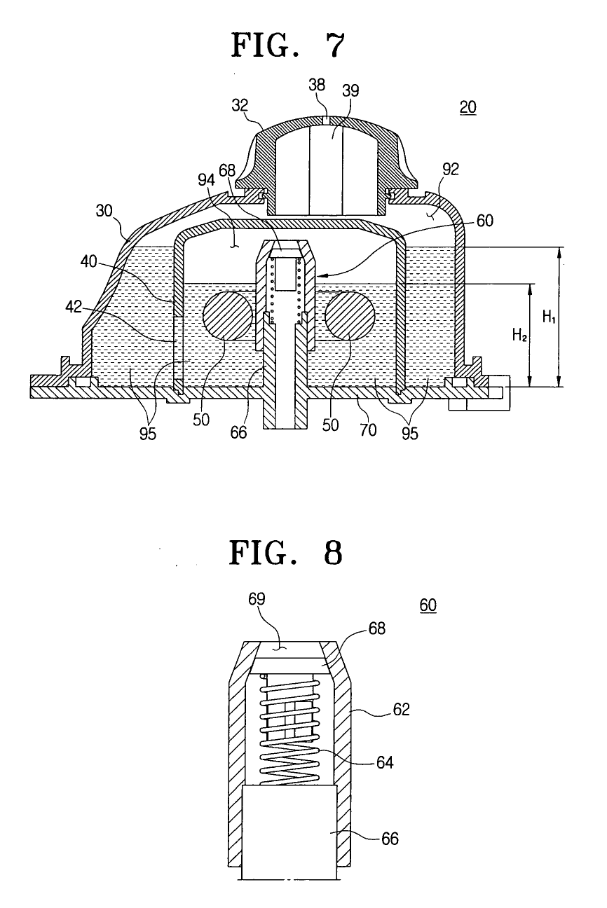

Hereinafter, operation of the steam generating apparatus 20 according to an embodiment of the present disclosure as described above will be explained with reference to FIGS. 7 to 10.

FIG. 7 is a sectional view illustrating the steam generating apparatus 20 in which water is stored before the heater 50 turns on, FIG. 8 is an enlarged sectional view illustrating the nozzle unit 60 of the FIG. 7 for showing the inside of the nozzle unit 60.

Referring to FIG. 7, when a user opens the cap 32 and pours water into the water inlet 31 (see FIG. 2), water 95 fills the first inner space 92 of the first water tank 30, and flows into the second inner space 94 of the second water tank 40 through the opening 42 formed at the second water tank 40. When the predetermined amount of water is poured, the steam generating apparatus 20 becomes the state as shown in FIG. 7. In other words, the second inner space 94 of the second water tank 40 is under a pressure higher than the atmosphere pressure, and the first inner space 92 between the first water tank 30 and the second water tank 40 always is under the atmosphere pressure because the first inner space 92 is in fluid communication with the atmosphere through the hole 38. Therefore, referring to FIG. 7, a water level (H1) of the first inner space 92 of the first water tank 30 is always higher than a water level (H2) of the second water tank 40. Also, as shown in FIG. 8, before steam generates, the spring 64 of the nozzle unit 60 remains pressing the piston member 68 in a direction of the discharging port 69 so that the discharging port 69 is closed. As a result, the nozzle unit 60 remains a closed state. Thus, elastic member 64 has a larger spring force than the pressure in second inner space 94 due to water 95 alone.

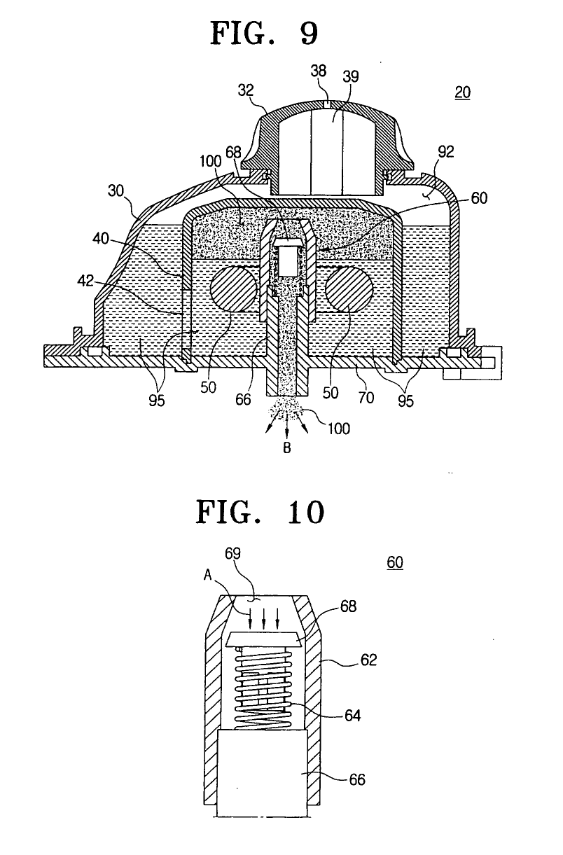

When the heater 50 turns on, the heat is generated to heat the water stored in the second water tank 40. As a result, the water stored in the second water tank 40 evaporates into steam 100 as shown in FIG. 9. When steam 100 is generated, the pressure of the second inner space 94 of the second water tank 40 is increased. When the force that the steam 100 presses the piston member 68 becomes larger than the force that the spring 64 presses the piston member 68, the piston member 68 presses the spring 64 down, thereby moving in a direction of arrow A as shown in FIG. 10. When the piston member 68 moves the discharging port 69 to be opened, the high-pressure steam 100 is discharged to outside in a direction of arrow B of FIG. 9 through the discharging port 69 and the steam pipe 66. An injection pressure of the steam may be determined by an elastic coefficient of the spring 64 of the nozzle unit 60. When the elastic coefficient of the spring 64 is K, and a distance that the spring 64 is moved down is X, the injection pressure F of the steam discharged from the second water tank 40 becomes KX. While steam is being discharged through the nozzle unit 60, the pressure of the second inner space 94 of the second water tank 40 is decreased, and water flows into the second water tank 40 through the opening 42 formed at the sidewall of the second water tank 40 as much as the amount of the discharged steam. Therefore, because the first inner space 92 of the first water tank 30 and the second inner space 94 of the second water tank 40 can store water, a water storing capacity of the steam generating apparatus 20 according to the present disclosure is large. However, because the only water stored in the second water tank 40 is heated, it is short a waiting time that a user waits for steam to generate. Also, when the user needs a small amount of steam, the heat loss is decreased because only some of the stored water is heated.

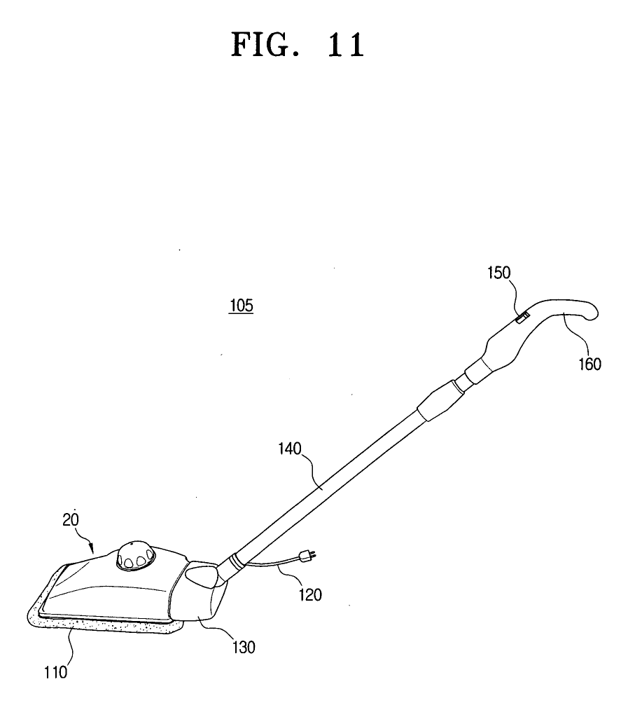

The steam generating apparatus 20 with above-described structure can be used in various apparatuses requiring steam such as a steam cleaner as shown in FIG. 11. FIG. 11 shows a steam cleaner 105 using the steam generating apparatus 20 according to above-described embodiment. The steam cleaner 105 includes the steam generating apparatus 20 according to the above-described embodiment, a wet cloth 110 mounted on a bottom surface of the steam generating apparatus 20, a connecting pipe 140, a handle 160, a connector unit 130 connecting the connecting pipe 140 and the steam generating apparatus 20, a power switch 150 disposed at the handle 160, and a power cord 120 connecting the heater 50 (see FIG. 2) of the steam generating apparatus 20 and the electric power source 80 (see FIG. 1).

As described above, the steam generating apparatus according to an embodiment of the present disclosure can store a large amount of water and shorten the time that to generate steam takes.

Also, when a user wants a small amount of steam, the steam generating apparatus according to the present disclosure does not need to heat a large amount of water so that the heat loss is decreased.

While the embodiments of the present disclosure have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the disclosure.

What is claimed is:

1. A steam generating apparatus comprising:
a first water tank configured to store water;
a second water tank in fluid communication with the first water tank so that the water flows into the second water tank from the first water tank; and
a heater inside the second water tank, wherein the heater heats only the water inside the second water tank so as to generate steam.

2. The steam generating apparatus of claim 1, further comprising:
a nozzle unit disposed in the second water tank;
wherein the steam from the second water tank is dischared through the nozzle unit to cause a pressure difference between the first water tank and the second water tank, the pressure difference being sufficient such that the water in the first water tank flows into the second water tank.

3. The steam generating apparatus of claim 2, wherein the second water tank is disposed inside the first water tank.

4. The steam generating apparatus of claim 3, wherein the first water tank comprises:
a water inlet through which the water is poured; and
a cap selectively opening or closing the water inlet.

5. The steam generating apparatus of claim 4, wherein the second water tank comprises an opening formed at a sidewall of the second water tank, and
wherein the water stored in the first water tank flows into the second water tank through the opening.

6. The steam generating apparatus of claim 1, wherein the first water tank is under the atmosphere pressure because the first water tank is in fluid communication with outside, and the second water tank is under a pressure higher than the atmosphere pressure so that a water level of the first water tank is higher than that of the second water tank.

7. The steam generating apparatus of claim 6, wherein the first water tank comprises a water inlet for pouring water and a cap for selectively opening or closing the water inlet, and wherein the second water tank comprises a nozzle unit for discharging steam.

8. The steam generating apparatus of claim 7, further comprising a hole is formed in the cap so that a first inner space of the first water tank is in fluid communication with outside.

9. The steam generating apparatus of claim 7, wherein the nozzle unit is closed at normal times, wherein when the pressure of steam of the second water tank is increased, the nozzle unit is opened the steam discharged to outside, and wherein when the pressure of the steam of the second water tank is decreased, the nozzle unit is closed again.

10. The steam generating apparatus of claim 9, wherein the nozzle unit comprises:
a steam pipe disposed through a bottom surface of the second water tank;
a case wrapping around at least some part of the steam pipe and having a discharging port;
a piston member disposed inside the case so as to open or close the discharging port; and
an elastic member disposed between the piston member and the steam pipe.

11. The steam generating apparatus of claim 10, wherein at least part of the piston member touching the discharging port is made of a soft material.

12. A steam generating apparatus comprising:
a first water tank in fluid communication with an outside of the steam generating apparatus;
a second water tank in the first water tank so that a first inner space is defined between the first and second tanks and a second inner space is defined by the second water tank;
an opening formed at a sidewall of the second water tank so that the first and second inner spaces are in fluid communication;
a heater inside the second inner space, the heater being configured to generate steam from water inside the second inner space; and
a nozzle fluidly communicating between the second inner space and the outside when the nozzle is in an open position.

13. The steam generating apparatus of claim 12, wherein the first water tank comprises a water inlet fluidly communicating with the outside so that water in the first inner space is at atmospheric pressure.

14. The steam generating apparatus of claim 13, further comprising a cap for selectively opening and closing the water inlet, the cap having a hole so that the first inner space is in fluid communication with the outside.

15. The steam generating apparatus of claim 13, wherein the nozzle is normally closed so that water in said second inner space is under a pressure higher than the atmospheric pressure.

16. The steam generating apparatus of claim 15, wherein the nozzle unit comprises an elastic member maintaining the nozzle unit in the normally closed position, and wherein the elastic member is configured so that steam pressure in the second inner space is sufficient to move the nozzle unit to the open position.

17. The steam generating apparatus of claim 13, wherein the nozzle has a normally closed position so that water in the first inner space has a first water level and water the second inner space has a second water level, said first water level being higher than the second water level.

18. The steam generating apparatus of claim 17, wherein the nozzle unit comprises an elastic member maintaining the nozzle unit in the normally closed position, and wherein the elastic member is configured so that steam pressure in the second inner space is sufficient to move the nozzle unit to the open position.
